(19) United States
(12) Patent Application Publication
(10) Pub. No.: US 2026/0214499 A1
(43) Pub. Date: Jul. 23, 2026

(54) SPS/CG AND TIME DILATION

(71) Applicant: QUALCOMM Incorporated, San Diego, CA (US)

(72) Inventors: Diana MAAMARI, San Diego, CA (US); Gabi SARKIS, San Diego, CA (US); Ahmed Attia ABOTABL, San Diego, CA (US)

(21) Appl. No.: 19/035,755

(22) Filed: Jan. 23, 2025

(51) Int. Cl. H04W 28/02; H04W 28/20; H04W 72/0446

(52) U.S. Cl. CPC H04W 28/0242; H04W 28/20; H04W 72/0446

(57) ABSTRACT

A method for wireless communication at a user equipment (UE) and related apparatus are provided. In the method, the UE receives an indication of a reduced peak throughput mode from a network entity. The reduced peak throughput mode indicates a relaxation of processing timeline and scheduling restrictions in the time domain. The UE further receives a first semi-persistent scheduling (SPS) configuration for one or more communication occasions that are aligned with the reduced peak throughput mode. The one or more communication occasions occur at a first throughput that is lower than a second throughput or a first processing timeline that is longer than a second timeline processing prior to the reception of the indication of the reduced peak throughput mode. The UE then communicates with the network entity during the one or more communication occasions based on the first SPS configuration.

### TECHNICAL FIELD

The present disclosure relates generally to communication systems and, more particularly, to resource scheduling wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to receive, from a network entity, an indication of a reduced peak throughput mode indicating a relaxation of processing timeline and scheduling restrictions in a time domain; receive, from the network entity, a first SPS configuration for one or more communication occasions, where the one or more communication occasions are aligned with the reduced peak throughput mode, where the one or more communication occasions occur at one or more of a first throughput that is lower than a second throughput prior to reception of the indication of the reduced peak throughput mode, or a first processing timeline that is longer than a second timeline processing prior to the reception of the indication of the reduced peak throughput mode; and communicate, based on the first SPS configuration, with the network entity during the one or more communication occasions.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to transmit, to a UE, an indication of a reduced peak throughput mode indicating a relaxation of processing timeline and scheduling restrictions in a time domain; transmit, to the UE, a first SPS configuration for one or more communication occasions, where the one or more communication occasions are aligned with the reduced peak throughput mode, where the one or more communication occasions occur at one or more of a first throughput that is lower than a second throughput prior to transmission of the indication of the reduced peak throughput mode, or a first processing timeline that is longer than a second timeline processing prior to the transmission of the indication of the reduced peak throughput mode; and communicate, based on the first SPS configuration, with the UE during the one or more communication occasions.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of energy efficient scheduling.

FIG. 5 is a diagram illustrating an example of energy efficient scheduling.

FIG. 6 is a diagram illustrating an example of semi-persistent scheduling (SPS) scheduling when energy efficient scheduling is used in accordance with various aspects of the present disclosure.

FIG. 7 is a diagram illustrating an example of SPS scheduling in accordance with various aspects of the present disclosure.

FIG. 8 is a call flow diagram illustrating a method of wireless communication in accordance with various aspects of the present disclosure.

FIG. 9 is a flowchart illustrating methods of wireless communication at a UE in accordance with various aspects of the present disclosure.

FIG. 10 is a flowchart illustrating methods of wireless communication at a network entity in accordance with various aspects of the present disclosure.

FIG. 11 is a diagram illustrating an example of a hardware implementation for an example apparatus and/or UE.

FIG. 12 is a diagram illustrating an example of a hardware implementation for an example network entity.

### DETAILED DESCRIPTION

In wireless communication, energy efficient scheduling allows user equipment (UE) to operate with reduced peak throughput to save power consumption. The energy efficient scheduling achieves the reduced peak throughput by, for example, ensuring that UE does not receive any scheduling following a wideband physical downlink shared channel (PDSCH) and relaxing the timing condition for feedback (e.g., allowing the UE additional time to send feedback). Semi-persistent scheduling (SPS), on the other hand, involves the semi-persistent allocation of resources for data that needs to be transmitted regularly. Configuring SPS concurrently with energy efficient scheduling may lead to scheduling conflicts. For example, in energy efficient scheduling, there may be a gap following each PDSCH scheduling, during which the UE does not expect to receive any PDSCH. If the UE is also configured with SPS, an SPS occasion may overlap with the gap, leading to scheduling conflicts. Example aspects presented herein provide methods and apparatus for handling SPS when energy efficient scheduling is used. In some examples, when the UE is configured with SPSs, the configuration of the SPS periodicity may be restricted to align with the scheduling duty cycle of the energy efficient scheduling, the SPS occasions overlapping with the gap may be regarded as invalid, or two sets of SPS configurations may be maintained and selected based on the normal or energy-efficient scheduling mode.

Various aspects relate generally to wireless communication. Some aspects more specifically relate to SPS or configured grant (CG) resource scheduling and time dilation (e.g., the extension of time interval for certain types of transmissions, including feedback transmission). In some examples, a UE receives an indication of a reduced peak throughput mode from a network entity. The indication of the reduced peak throughput mode may indicate a relaxation of processing timeline and scheduling restrictions in a time domain. The UE further receives a first SPS configuration for one or more communication occasions from the network entity. The one or more communication occasions may be aligned with the reduced peak throughput mode, and the one or more communication occasions may occur at a first throughput that is lower than a second throughput or a first processing timeline that is longer than a second timeline processing prior to the reception of the indication of the reduced peak throughput mode. The UE then communicates with the network entity during the one or more communication occasions based on the first SPS configuration. In some aspects, the one or more communication occasions may include one or more semi-static PDSCH occasions, and the scheduling restrictions in the time domain may include a first number of guaranteed slots. The UE expects no downlink PDSCH scheduling, PDCCH, CSI-RS, or SSB measurement in the first number of guaranteed slots following a scheduled semi-static PDSCH. In some aspects, the first SPS configuration may further indicate a transmission gap between two adjacent semi-static PDSCH occasions in the one or more semi-static PDSCH occasions, and the transmission gap may be based on the time-domain resource allocation (TDRA) of the first SPS configuration, or the modulation and coding scheme (MCS). In some aspects, the UE may receive multiple SPS configurations including the first SPS configuration; and activate the first SPS configuration in response to a periodicity associated with the first SPS configuration being aligned with a duty cycle associated with the scheduling restrictions.

Particular aspects of the subject matter described in this disclosure can be implemented to realize one or more of the following potential advantages. In some examples, by integrating SPS with energy efficient scheduling, the described techniques reduce the power consumption of UE and improve network resource utilization. In some examples, by allowing UE to select from multiple SPS configurations based on network conditions or UE capability, the described techniques ensure that resource scheduling can be adapted to varying traffic conditions, such as those from different applications or services, thereby improving the efficiency of wireless communication. In some examples that involve burst traffic, such as Extended Reality (XR) burst traffic, the described techniques allow back-to-back PDSCHs when high data rates are needed and provide a relaxed scheduling timeline when lower data rates suffice, thereby improving resource utilization and reducing unnecessary power usage.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

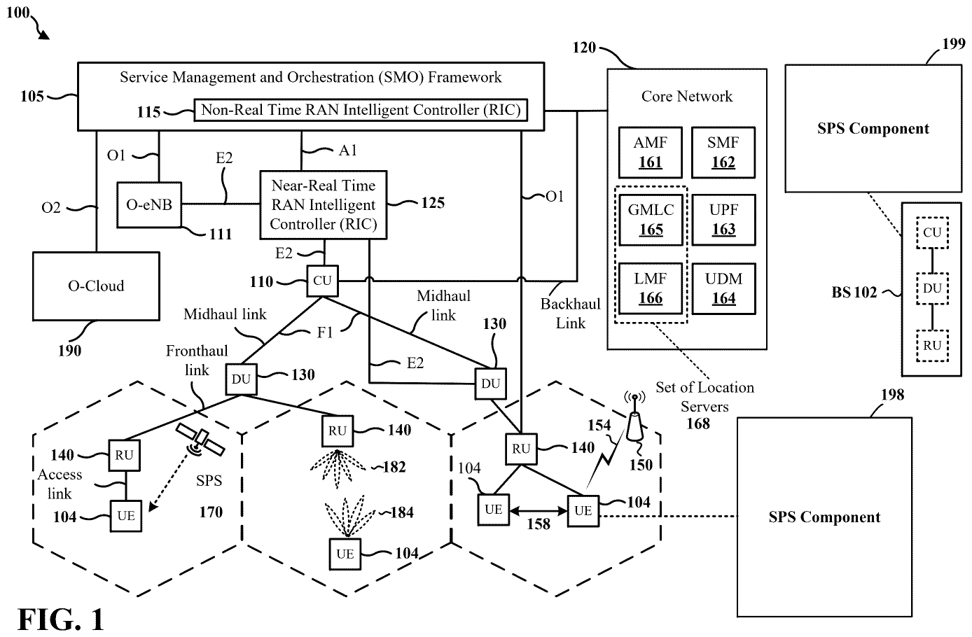

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like.

When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the SPS component 198. The SPS component 198 may be configured to receive, from a network entity, an indication of a reduced peak throughput mode indicating a relaxation of processing timeline and scheduling restrictions in a time domain; receive, from the network entity, a first SPS configuration for one or more communication occasions, where the one or more communication occasions are aligned with the reduced peak throughput mode, where the one or more communication occasions occur at one or more of a first throughput that is lower than a second throughput prior to reception of the indication of the reduced peak throughput mode, or a first processing timeline that is longer than a second timeline processing prior to the reception of the indication of the reduced peak throughput mode; and communicate, based on the first SPS configuration, with the network entity during the one or more communication occasions. In certain aspects, the base station 102 may include the SPS component 199. The SPS component 199 may be configured to transmit, to a UE, an indication of a reduced peak throughput mode indicating a relaxation of the processing timeline and scheduling restrictions in a time domain; transmit, to the UE, a first SPS configuration for one or more communication occasions, where the one or more communication occasions are aligned with the reduced peak throughput mode, where the one or more communication occasions occur at one or more of a first throughput that is lower than a second throughput prior to transmission of the indication of the reduced peak throughput mode, or a first processing timeline that is longer than a second timeline processing prior to the transmission of the indication of the reduced peak throughput mode; and communicate, based on the first SPS configuration, with the UE during the one or more communication occasions. Although the following description may be focused on 5G NR, the concepts described herein may be applicable to other similar areas, such as LTE, LTE-A, CDMA, GSM, and other wireless technologies.

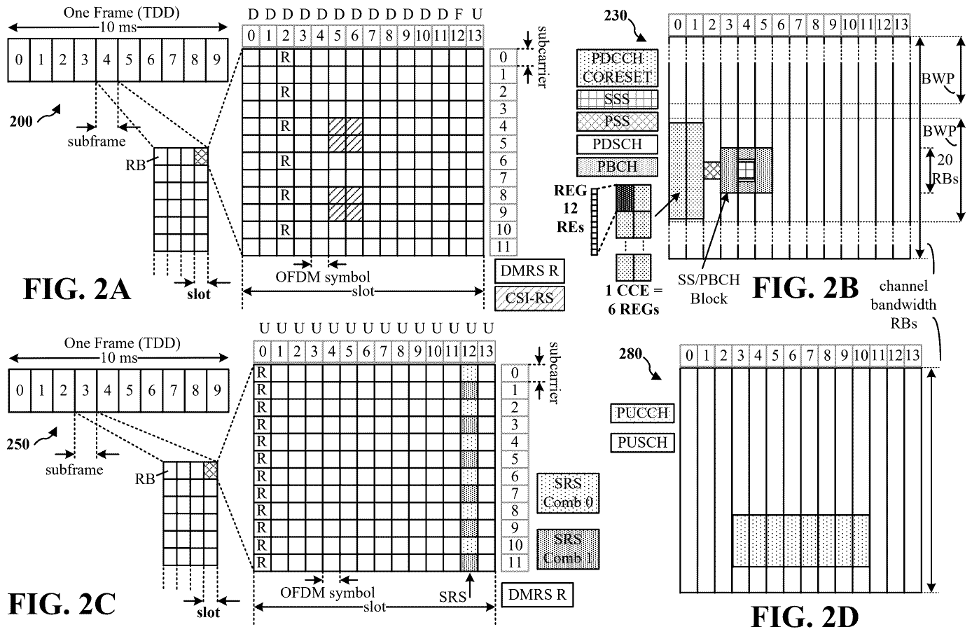

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with l/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

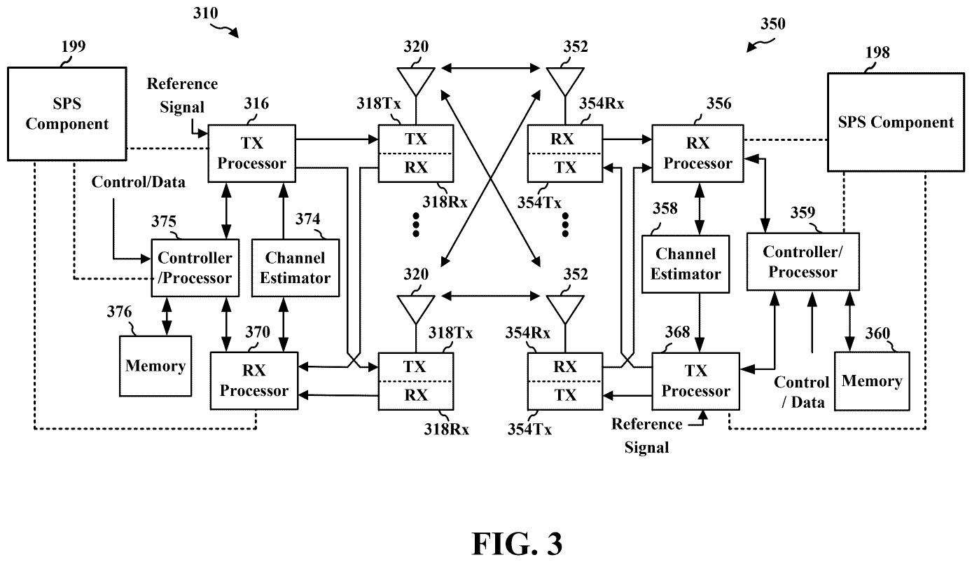

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the SPS component 198 of FIG. 1.

At least one of the TX processor 316, the RX processor 370, and the controller/processor 375 may be configured to perform aspects in connection with the SPS component 199 of FIG. 1.

In wireless communication, energy efficient scheduling allows UE to operate with reduced peak throughput to save power consumption. The energy efficient scheduling achieves the reduced peak throughput by, for example, ensuring that UE does not receive any scheduling following a wideband PDSCH and relaxing the timing condition for feedback (e.g., allowing the UE additional time to send feedback). SPS, on the other hand, involves the semi-persistent allocation of resources for data that needs to be transmitted regularly. Configuring SPS concurrently with energy efficient scheduling may potentially lead to scheduling conflicts. For example, in energy efficient scheduling, there may be a gap following each PDSCH scheduling, during which the UE does not expect to receive any PDSCH. If the UE is also configured with SPS, an SPS occasion may overlap with the gap, leading to scheduling conflicts. Example aspects presented herein provide methods and apparatus for handling SPS when energy efficient scheduling is used. In some examples, when the UE is configured with SPSs, the configuration of the SPS periodicity may be restricted to align with the scheduling duty cycle of the energy efficient scheduling, the SPS occasions overlapping with the gap may be regarded as invalid, or two sets of SPS configurations may be maintained and selected based on the normal or energy-efficient scheduling mode.

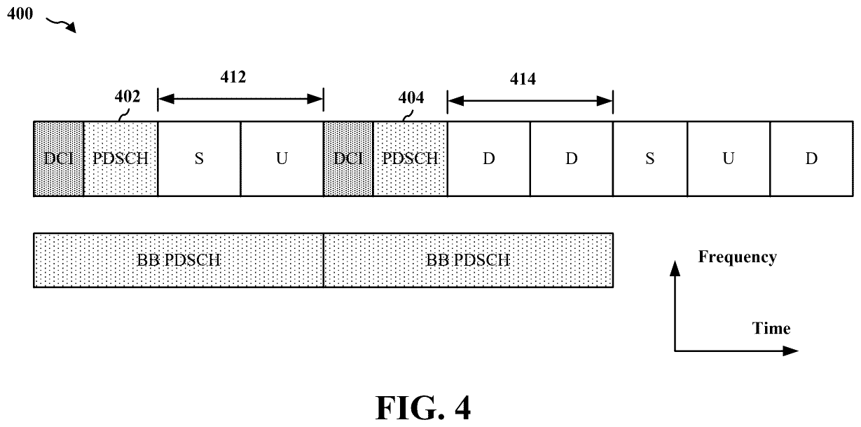

Energy efficient scheduling is a scheduling scheme that reduces peak throughput by guaranteeing that UE does not receive any scheduling following a wideband PDSCH. Energy efficient scheduling also allows a relaxed (or extended) feedback timeline for the UE (e.g., allowing additional time for UE to send the feedback). The combination of the guaranteed slots where the UE does not receive any scheduling and the relaxed (or extended) feedback timeline allows the UE to operate in a reduced throughput, which in turn helps to reduce energy consumption. In some examples, the energy efficient scheduling scheme may involve a time scaling method where the UE is configured with a duty cycle. This duty cycle may include one or more ON periods, during which the UE may receive, for example, PDSCH, and one or more OFF periods, during which the UE does not expect any PDSCH. For example, the UE may not expect any PDSCH for a certain number of slots (e.g., X slots) following a wideband PDSCH. FIG. 4 is a diagram 400 illustrating an example of energy efficient scheduling. As shown in FIG. 4, when a UE is configured with energy efficient scheduling, after receiving a wideband PDSCH, such as PDSCH 402, 404, the UE does not expect any PDSCH for a certain number of subsequent slots, such as the time interval 412, 414.

Energy efficient scheduling allows for the decoupling of radio frequency (RF) and baseband power states, which contributes to a substantial reduction in energy consumption by the UE. For example, when downlink (DL) data demands are less than peak throughput levels, gaps may be guaranteed between successive PDSCH transmissions (e.g., between successive PDSCH 402, 404), and the feedback timeline may be relaxed or extended (e.g., allowing additional time for the UE to send the feedback). In some examples, the UE may move the RF to a high-power state, and keep the baseband in a lower-power state.

In some examples, such as in NR wireless communication, UE may move its internal baseband clock and voltage to a higher power state when it moves to wideband (WB) scheduling. This shift into high-power mode may lead to an increase in clock frequency and generally a higher supply voltage to support the higher clock frequency, which may lead to a significant increase (e.g., a quadratic increase) in power consumption and potential leakage. To address these issues, in energy efficient scheduling, the network may inform the UE of the duration for which it may be scheduled with WB, allowing the UE to set its clock frequency and voltage as needed, without continuously maintaining the highest settings corresponding to the wideband scheduling. In some examples, the UE may be guaranteed that it will not receive any PDSCH following a wideband PDSCH, and the feedback timeline may be relaxed or extended (e.g., the UE is allowed extra time to send the feedback).

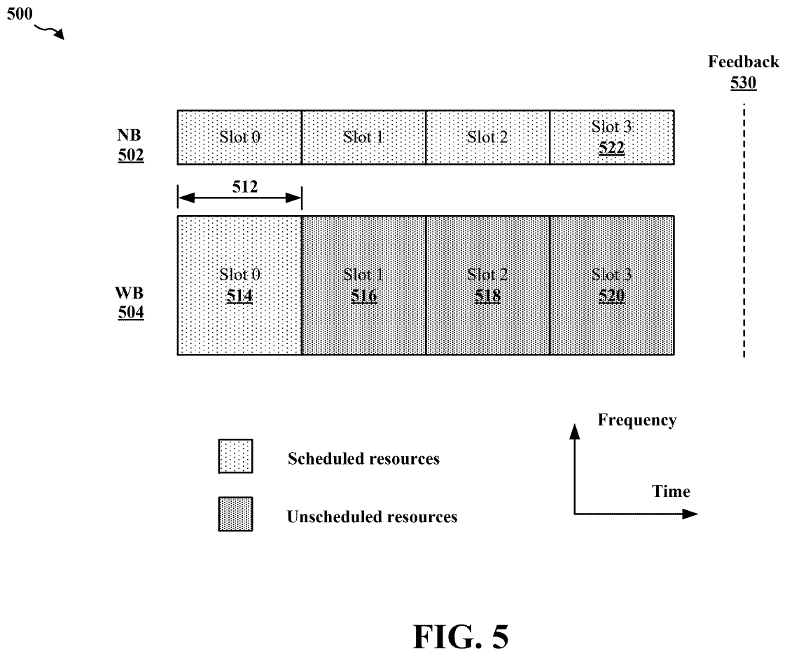

FIG. 5 is a diagram 500 illustrating an example of energy efficient scheduling. As shown in FIG. 5, when a UE moves to wideband (WB) scheduling 504 from narrow band (NB) scheduling 502, the network may inform the UE of the duration for which it may be scheduled with WB (e.g., the duration 512), and the UE may be guaranteed that it will not receive any PDSCH following a wideband PDSCH (e.g., at slot 0 514). For example, the UE may not receive any PDSCH at slot 1 516, slot 2 518, and slot 3 520 following a wideband PDSCH at slot 0 514. In some examples, the UE may be allowed more time to transmit the feedback 530 after the PDSCH at slot 0 514 than, for example, after the PDSCH at slot 3 522.

In wireless communication, semi-persistent scheduling (SPS) and configured grant (CG) scheduling may be used to manage downlink and uplink traffic that occurs in periodic bursts. This type of traffic, often seen in applications such as video streaming, online gaming, or Extended Reality (XR) devices, may be referred to as “burst traffic.”

In some examples, SPS may include the pre-configuration of allocated resources via radio resource control (RRC) signaling, and the physical downlink control channel (PDCCH) may be activated and released via DCI. For example, DCI of formats 1_0 and 1_1 may be used to activated PDCCH, and DCI of format 1_0 may be used to release the PDCCH. In some examples, CG scheduling may be categorized into two types: Type 1 CG and Type 2 CG. Type 1 CG may be fully configured by the RRC without any need for PDCCH activation or deactivation, while Type 2 CG may operate similarly to SPS with RRC-based configurations and PDCCH activations via DCI (e.g., DCI of formats 0_0 and 0_1), and PDCCH releases using DCI (e.g., DCI of format 0_0).

In some examples, SPS scheduling may support multiple active SPS configurations, which may respectively correspond to, for example, different service types. In some examples, these active SPS configurations may be jointly activated and released. For example, DCI of format 1_2 may be used for the activation, and DCI of format 1_1 or 1_2 may be used for the release. The SPS periodicity (e.g., the interval at which SPS resources are allocated) may vary based on conditions such as the amount of data to be transmitted. As an example, SPS scheduling may have a minimum periodicity of one slot.

In some examples, CG scheduling may support multiple active CG configurations, which may respectively correspond to, for example, different service types. In some examples, for Type 2 CG, these active CG configurations may be jointly activated and released using DCI (e.g., using DCI of formats 0_2 for activation, and DCI of format 0_1 and 0_2 for release). In some examples, the CG periodicity (e.g., the interval at which CG resources are allocated) may vary based on conditions such as the amount of data to be transmitted. In some examples, CG scheduling may have a minimum periodicity of several symbols (e.g., two or seven symbols). As used herein, the “activation” of a scheduling configuration (e.g., an SPS configuration or a CG configuration) refers to the process by which the network sets up and starts applying the scheduling configuration for a UE, and the “release” of a scheduling configuration (e.g., an SPS configuration or a CG configuration) refers a process by which the network informs the UE that the previously allocated resources (e.g., SPS resources or CG resources) are no longer reserved for its use and may be released for other transmissions.

Example aspects presented herein provide methods and apparatus for managing SPS or CG scheduling when energy efficient scheduling is used in wireless communication. These methods involve determining the most effective way to manage SPS (or CG) scheduling while maintaining the conditions of energy efficient scheduling, including guaranteed slots where UE does not expect any PDSCH following a wideband PDSCH and the relaxed timeline for feedback.

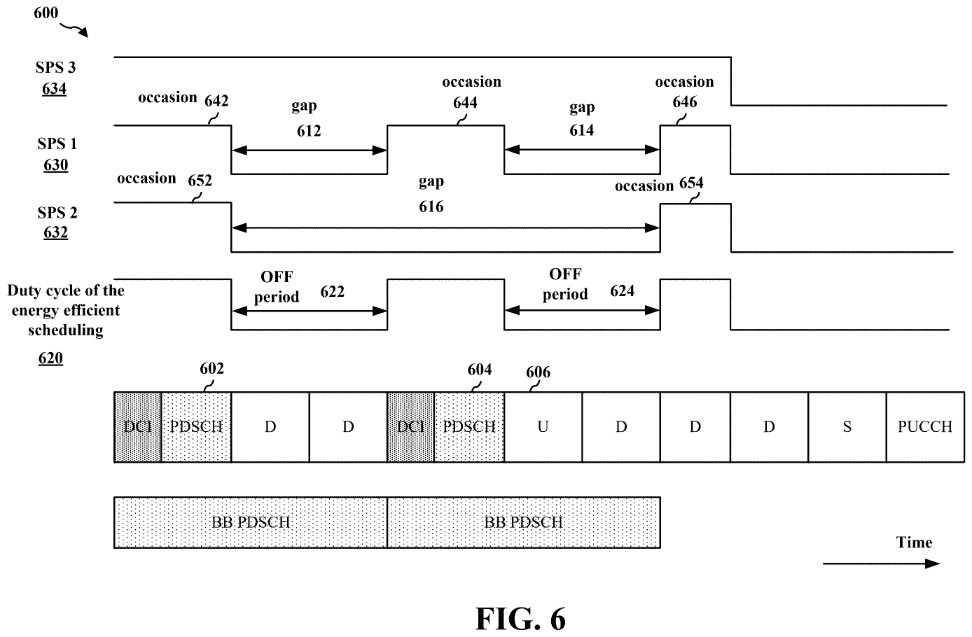

FIG. 6 is a diagram 600 illustrating an example of SPS scheduling when energy efficient scheduling is used in accordance with various aspects of the present disclosure. CG scheduling may operate based on a similar principle to that of the SPS scheduling. As shown in FIG. 6, when managing SPS in energy efficient scheduling, the SPS configurations may be designed to align with the UE duty cycle associated with the energy efficient scheduling, ensuring that the reduced peak throughput and relaxed feedback timeline are satisfied. In some examples, all SPS occasions of an SPS configuration (e.g., SPS 1 630, 632) may be scheduled with gaps, such as gaps 612, 614, 616. For example, for SPS 1 630, the SPS occasions 642, 644, 646 may be separated by gaps 612 and 614. For example, for SPS 2 632, the SPS occasions 652, 654 may be separated by gap 616. In some examples, the gaps (e.g., gaps 612, 614, 616) may be aligned with the duty cycle of the UE, which is designed to reduce peak throughput. For example, in energy efficient scheduling, the UE may be guaranteed a certain number of slots following a wideband PDSCH transmission (e.g., PDSCH 602, 604), and the UE does not expect various transmissions within the duration of these number of slots, including downlink PDSCH scheduling, PDCCH, channel state information-reference signal (CSI-RS), or synchronization signal block (SSB) measurement. These number of slots may correspond to the OFF periods of the duty cycle, such as 622 and 624, and the gaps (e.g., gaps 612, 614, 616) associated with the SPS occasions may be aligned with these duty cycle of the UE (e.g., the OFF periods of the duty cycle 620 at 622 and 624). As used herein, gaps being “aligned” with a duty cycle means the gaps either coincide with or encompass the OFF periods of the duty cycle. For example, gaps 612 and 614 coincide with the OFF periods of the duty cycle 620 at 622 and 624, respectively. For example, a gap 616 may encompass the OFF periods of the duty cycle 620 at 622 and 624.

This alignment means the UE does not expect an activated SPS configuration with a periodicity smaller than the duty cycle of the UE, and the UE does not expect any SPS configurations with a periodicity and slot offset that is different from the duty cycle.

In some examples, the indications of the SPS occasions may be included in a part of a bandwidth part (BWP) configuration, which may include the SPS configuration separate from the dynamic grant (DG) physical shared channel (DG-PDSCH) time scaling and relaxed feedback timeline. In some examples, the gaps between the SPS occasions (e.g., gaps 612, 614, 616) may be inserted based on the time division resource allocation (TDRA) of the SPS configuration, the modulation and coding scheme (MCS), among other factors. In some examples, the UE may apply an offset to the timeline between the PDSCH transmission and the acknowledgment (ACK), thereby relaxing the feedback timeline (e.g., allowing additional time for the UE to transmit the ACK).

In some examples, the SPS occasions may collide (or overlap) with scheduling gaps (e.g., gaps 612, 614, 616). In these scenarios, various measures may be implemented to manage the scheduling process. In some examples, if a UE is configured with a duty cycle that semi-statically inserts gaps for limited throughput (TPUT) mode. In such configurations, the UE is not expected to receive SPS occasions that collide (or overlap) with these gaps during the reduced peak throughput time dilation (a time period used to achieve reduced peak throughput). This setup is beneficial if the network does not configure the UE with specific SPS that is aligned with the duty cycle. In scenarios where the UE does not have a configured duty cycle, the UE may consider any SPS occasions that overlap with gaps as invalid.

In some examples, if the UE is not configured with a duty cycle, the UE may not expect to receive two SPS occasions within a timeline (e.g., time duration between these two SPS occasions) shorter than the duration of gaps from the first SPS PDSCH (e.g., PDSCH 602) to the second SPS PDSCH (e.g., PDSCH 604). In some examples, when the UE receives an SPS PDSCH, the UE may consider subsequent SPS-PDSCHs occur within a defined time period (e.g., X milliseconds) after the initial SPS-PDSCH as invalid. For example, when the UE receives an SPS PDSCH 602, the UE may consider another SPS-PDSCH occur within the time period 622 after the received SPS PDSCH 602 as invalid (assuming the duration of time period 622 is less than the defined time period.

In some aspects, the UE may be configured with one or more SPS configurations. Among the one or more SPS configurations, those configurations whose periodicity aligns with the duty cycle of energy efficient scheduling may be activated or considered as a valid configuration. For example, one SPS configuration may be used during periods of high peak throughput with no scaling in time domain (e.g., no gaps for reduced peak throughput, such as SPS 3 634), while another SPS configuration may be applicable in reduced throughput settings with time dilation (e.g., gaps for reduced peak throughput, such as SPS 1 630 or SPS 2 632). When the UE is indicated to be operating under a reduced peak throughput setting, the UE may apply the SPS configuration with time dilation (e.g., SPS 1 630 or SPS 2 632), which is designed to overlap with the ON duration of the duty cycle, thus ensuring it is compatible with the energy efficient scheduling.

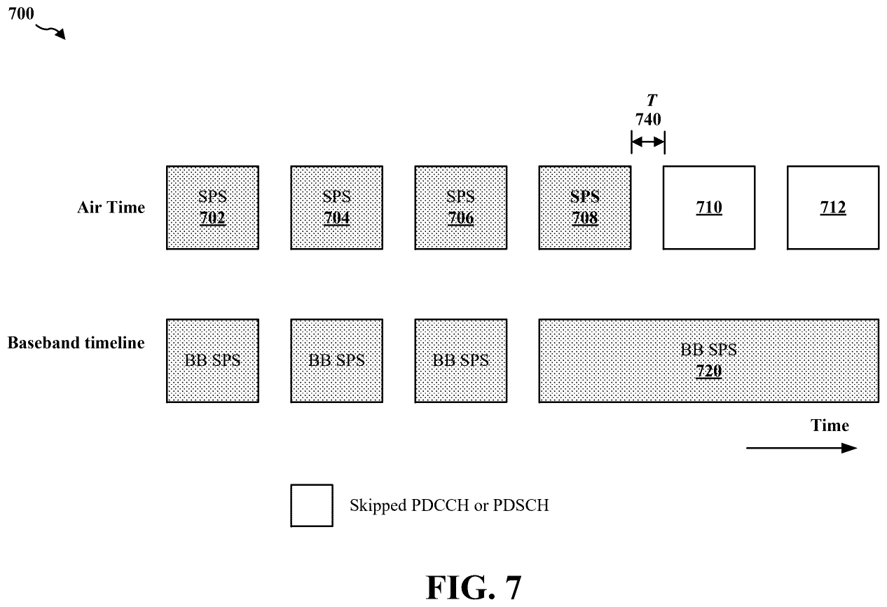

In some aspects, when handling burst traffic, such as XR burst traffic, the UE may be configured to receive a subset of SPS with scheduled gaps. This configuration is useful for handling burst traffic, such as XR traffic. For example, in scenarios involving XR, the UE may be scheduled to receive back-to-back PDSCHs to accommodate a burst of XR data. The UE may relax the baseband (BB) for the last PDSCH of this burst (e.g., allowing additional time to process after the last PDSCH). This scheduling strategy may include skipping the PDCCH or PDSCH at specific times. FIG. 7 is a diagram 700 illustrating an example of SPS scheduling in accordance with various aspects of the present disclosure. For example, as shown in FIG. 7, the UE may be scheduled to receive back-to-back PDSCHs (e.g., SPS occasions 702, 704, 706, 708) to accommodate a burst of XR data. The UE may relax the baseband (e.g., at 720) for the last PDSCH of this burst (e.g., at SPS occasion 708), allowing additional time to process after the last PDSCH. In some examples, the UE may skip the PDCCH or PDSCH occasions (e.g., at 710, 712) after the last PDSCH (e.g., at SPS occasion 708).

In some aspects, the UE may not expect to receive any SPS PDSCH with a relaxed timeline before a set timeline (e.g., T 740) from the last PDSCH received (e.g., at SPS occasion 708), and the last PDSCH may be a DG-PDSCH or an SPS-PDSCH. This relaxed timeline may provide the UE with sufficient time to adjust its BB clock to a lower setting, enhancing the efficiency of power usage.

In some aspects, when energy efficient scheduling is used, the scheduling of DG-PDSCH and SPS-PDSCH may be configured to comply with the energy efficient scheduling. For example, the UE may be configured not to expect any DG-PDSCHs to occur within the gap durations of an SPS-PDSCH.

In some aspects, when energy efficient scheduling is used, the scheduling of CG occasions with respect to the scheduling gaps in energy efficient scheduling may be configured based on the UE capabilities. In some examples, if supported by UE capability, the UE may consider CG-PUSCH occasions that collide (or overlap) with scheduled gaps (e.g., gaps 612, 614, 616) as valid and use these CG-PUSCH occasions for uplink transmission. For example, the UE may use CG-PUSCH occasion at 606 for uplink transmission even though it overlaps with gap 614 or 616. In some examples, the UE may consider CG-PUSCH occasions that collide (or overlap) with scheduled gaps (e.g., gaps 612, 614, 616) as invalid (e.g., when UE does not support the uplink transmission during the gaps). For example, if the uplink clock can drive the downlink (DL), the UE may indicate that it does not support uplink transmissions during these gaps, so as to prevent the uplink clock from influencing DL operations adversely. In this case, the UE may consider CG-PUSCH occasions that collide (or overlap) with scheduled gaps as invalid.

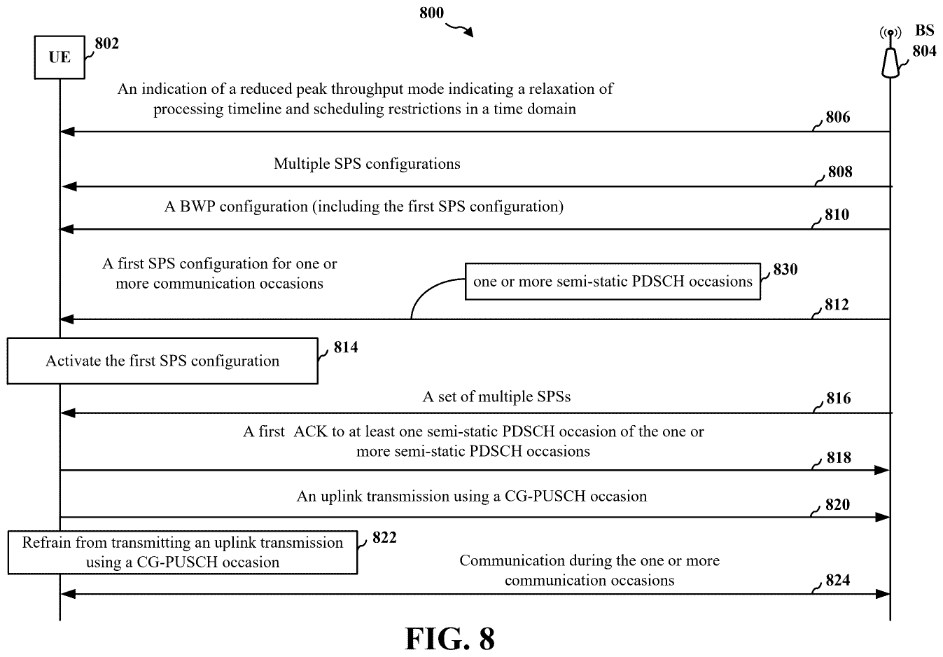

FIG. 8 is a call flow diagram 800 illustrating a method of wireless communication in accordance with various aspects of this present disclosure. Various aspects are described in connection with a UE 802 and a base station 804. The aspects may be performed by the UE 802 or the base station 804 in aggregation and/or by one or more components of a base station 804 (e.g., a CU 110, a DU 130, and/or an RU 140).

As shown in FIG. 8, at 806, the UE 802 may receive an indication of a reduced peak throughput mode from base station 804. The indication of the reduced peak throughput mode may indicate a relaxation of the processing timeline and scheduling restrictions in a time domain.

In some aspects, at 808, the UE 802 may receive multiple SPS configurations. The multiple SPS configuration may include the first SPS configuration that will be activated by the UE 802 (e.g., at 814) for communication with the base station 804 (e.g., at 824). For example, referring to FIG. 6, the multiple SPS configurations may include SPS 1 630, SPS 2 632, SPS 3 634.

In some aspects, at 810, the UE 802 may receive a BWP configuration from base station 804. The BWP configuration may include the first SPS configuration that will be activated by the UE 802 (e.g., at 814) for communication with the base station 804 (e.g., at 824).

In some aspects, rather than receiving the first SPS configuration as part of multiple SPS configurations (e.g., at 808) or within a BWP configuration (e.g., at 810), the UE may, at 812, the UE 802 may receive a standalone first SPS configuration directly from base station 804. In some examples, the first SPS configuration at 812 (or the first SPS configuration at 808 or 810) may indicate one or more communication occasions (e.g., communication occasions 642, 644, 646). The one or more communication occasions are aligned with the reduced peak throughput mode of the UE. In some examples, the one or more communication occasions may occur at a first throughput that is lower than a second throughput prior to reception of the indication of the reduced peak throughput mode (e.g., at 806). In some examples, the one or more communication occasions may occur at a first processing timeline that is longer than a second timeline processing prior to the reception of the indication of the reduced peak throughput mode (e.g., at 806). In some examples, the one or more communication occasions (e.g., communication occasions 642, 644, 646) include one or more semi-static PDSCH occasions.

At 814, the UE 802 may activate the first SPS configuration. For example, the UE 802 may receive the first SPS configuration at 812, as part of multiple SPS configurations (e.g., at 808), or as part of the BWP configuration (e.g., at 810). In some examples, the UE 802 may activate the first SPS configuration if the periodicity associated with the first SPS configuration is aligned with a duty cycle associated with the scheduling restrictions (at 806). For example, the UE 802 may activate the first SPS configuration (e.g., SPS 1 630) if the periodicity associated with the first SPS configuration (e.g., SPS 1 630) is aligned with a duty cycle associated with the scheduling restrictions (e.g., duty cycle 620).

At 816, the UE 802 may receive a set of multiple SPSs. The UE 802 may extend the processing timeline for the last SPS of the set of SPSs. The extended processing timeline for the last SPS may be longer than the processing timeline for any SPS before the last SPS in the set of SPSs. For example, referring to FIG. 7, the UE may receive a set of multiple SPSs (e.g., SPS occasions 702, 704, 706, 708), and the UE may extend the processing timeline for the last SPS of the set of SPSs.

At 818, the UE 802 may transmit a first ACK to at least one semi-static PDSCH occasion of the one or more semi-static PDSCH occasions to the base station 804. The first time interval between the first ACK and the at least one semi-static PDSCH occasion may be based on the first processing timeline, and the first time interval may be longer than a second time interval between a PDSCH occasion and a second ACK prior to the reception of the indication of the reduced peak throughput mode (e.g., at 806).

At 820, the UE 802 may transmit an uplink transmission to the base station 804 using a CG-PUSCH occasion. In some examples, the CG PUSCH occasion may overlap with a gap duration between adjacent semi-static PDSCH occasions of the one or more semi-static PDSCH occasions. For example, the UE may transmit an uplink transmission to the base station using a CG-PUSCH occasion (e.g., at 606), and the CG PUSCH occasion (e.g., at 606) may overlap with a gap duration between adjacent semi-static PDSCH occasions of the one or more semi-static PDSCH occasions (e.g., gap 614).

At 822, the UE 802 may refrain from transmitting (or avoid transmitting) an uplink transmission to the base station 804 at a CG PUSCH occasion if the CG PUSCH occasion overlaps with a gap duration between adjacent semi-static PDSCH occasions of the one or more semi-static PDSCH occasions.

At 824, the UE 802 may communicate with the base station 804 during the one or more communication occasions based on the first SPS configuration.

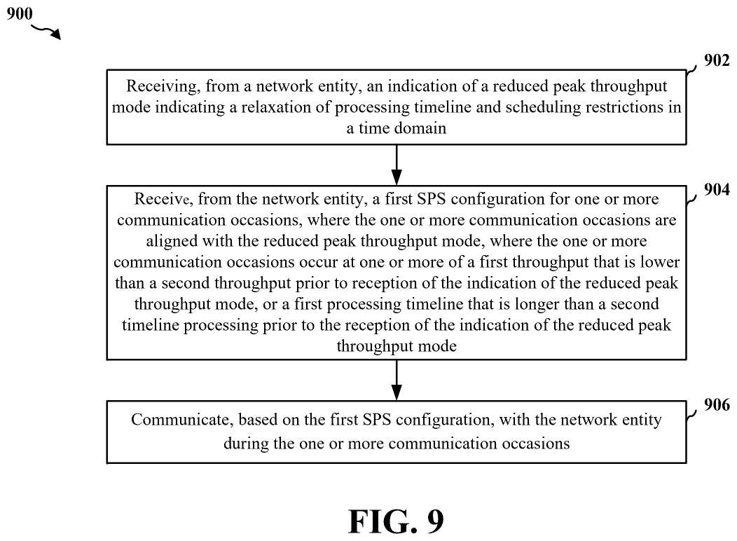

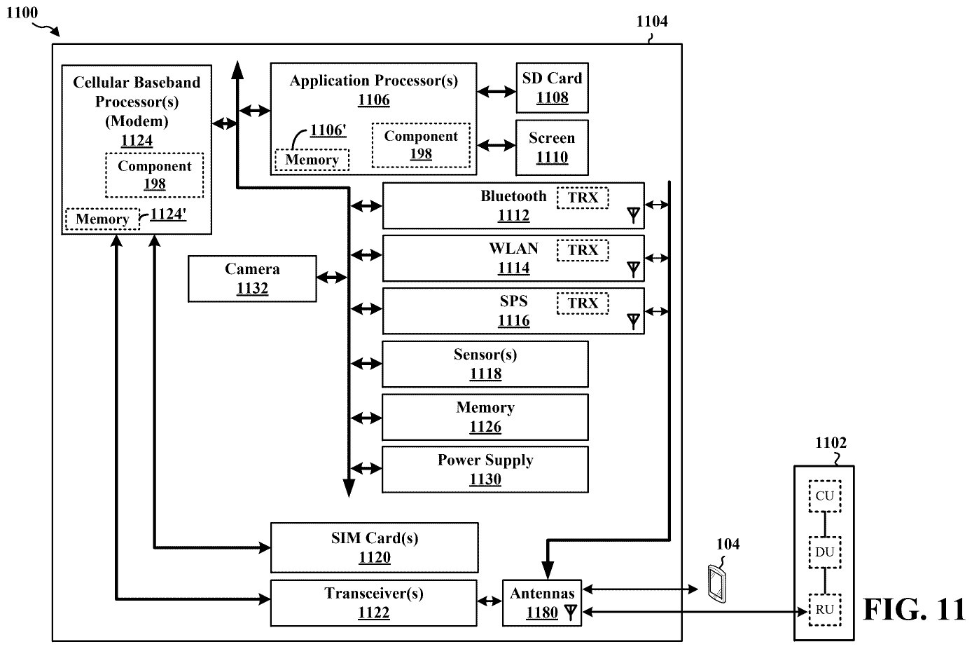

FIG. 9 is a flowchart 900 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 804; or the network entity 1102 in the hardware implementation of FIG. 11). The UE may be the UE 104, 350, 802, or the apparatus 1104 in the hardware implementation of FIG. 11. By integrating SPS with energy efficient scheduling, the methods reduce the power consumption of UE and improve network resource utilization. Additionally, by allowing UE to select from multiple SPS configurations based on network conditions or UE capability, the methods ensure that resource scheduling can be adapted to varying traffic conditions, such as those from different applications or services, thereby improving the efficiency of wireless communication. In some examples that involve burst traffic, such as XR burst traffic, the methods allow back-to-back PDSCHs when high data rates are needed and provide a relaxed scheduling timeline when lower data rates suffice, thereby improving resource utilization and reducing unnecessary power usage.

As shown in FIG. 9, at 902, the UE may receive an indication of a reduced peak throughput mode from the network entity. The indication of the reduced peak throughput mode may indicate a relaxation of the processing timeline and scheduling restrictions in a time domain. FIG. 5, FIG. 6, FIG. 7, and FIG. 8 illustrate various aspects of the steps in connection with flowchart 900. For example, referring to FIG. 8, the UE 802 may, at 806, receive an indication of a reduced peak throughput mode from the network entity (e.g., base station 804). The indication of the reduced peak throughput mode may indicate a relaxation of the processing timeline and scheduling restrictions in the time domain. In some aspects, 902 may be performed by the SPS component 198.

At 904, the UE may receive a first SPS configuration for one or more communication occasions from the network entity. The one or more communication occasions may be aligned with the reduced peak throughput mode, and the one or more communication occasions may occur at a first throughput that is lower than a second throughput prior to reception of the indication of the reduced peak throughput mode, or a first processing timeline that is longer than a second timeline processing prior to the reception of the indication of the reduced peak throughput mode. For example, referring to FIG. 8, the UE 802 may, at 812, receive a first SPS configuration for one or more communication occasions from the network entity (e.g., base station 804). Referring to FIG. 6, the one or more communication occasions (e.g., communication occasions 642, 644, 646) may be aligned with the reduced peak throughput mode of the UE (e.g., the duty cycle 620). In some examples, the one or more communication occasions (e.g., communication occasions 642, 644, 646) may occur at a first throughput that is lower than a second throughput prior to reception of the indication of the reduced peak throughput mode (e.g., at 806). In some examples, the one or more communication occasions (e.g., communication occasions 642, 644, 646) may occur at a first processing timeline that is longer than a second timeline processing prior to the reception of the indication of the reduced peak throughput mode (e.g., at 806). In some aspects, 904 may be performed by the SPS component 198.

At 906, the UE may communicate with the network entity during the one or more communication occasions based on the first SPS configuration. For example, referring to FIG. 8, the UE 802 may, at 824, communicate with the network entity (e.g., base station 804) during the one or more communication occasions (e.g., communication occasions 642, 644, 646) based on the first SPS configuration. In some aspects, 906 may be performed by the SPS component 198.

In some aspects, the one or more communication occasions may include one or more semi-static PDSCH occasions. For example, referring to FIG. 6 and FIG. 8, the one or more communication occasions (e.g., communication occasions 642, 644, 646) may include one or more semi-static PDSCH occasions 830.

In some aspects, the scheduling restrictions in the time domain may include a first number of guaranteed slots, and the UE expects no downlink PDSCH scheduling, PDCCH, CSI-RS, or SSB measurement in the first number of guaranteed slots following a scheduled semi-static PDSCH. For example, referring to FIG. 6, the scheduling restrictions in the time domain may include a first number of guaranteed slots (e.g., the OFF periods of the duty cycle at 622, 624), and the UE expects no downlink PDSCH scheduling, PDCCH, CSI-RS, or SSB measurement in the first number of guaranteed slots (e.g., the OFF periods of the duty cycle at 622, 624) following a scheduled semi-static PDSCH (e.g., PDSCH at 602 or 604).

In some aspects, the number of slots between adjacent semi-static PDSCH occasions of the one or more semi-static PDSCH occasions may be greater than or equal to the gap slot associated with the scheduling restrictions. For example, referring to FIG. 6, the number of slots between adjacent semi-static PDSCH occasions of the one or more semi-static PDSCH occasions (e.g., gaps 612 or 616) may be greater than or equal to the gap slot associated with the scheduling restrictions (e.g., OFF period of the duty cycle at 622).

In some aspects, the slot offset of the one or more semi-static PDSCH occasions may be aligned with the duty cycle of the UE associated with the scheduling restrictions. For example, referring to FIG. 6, the slot offset of the one or more semi-static PDSCH occasions (e.g., the slot offset at SPS 1 630) may be aligned (or matched) with the duty cycle 620 of the UE associated with the scheduling restrictions.

In some aspects, the one or more semi-static PDSCH occasions may not overlap with one or more OFF periods of the duty cycle of the UE associated with the scheduling restrictions. For example, referring to FIG. 6, the one or more semi-static PDSCH occasions (e.g., occasions 642, 644, 646, 652, 654) may not overlap with one or more OFF periods (e.g., OFF periods at 622, 624) of the duty cycle 620 of the UE associated with the scheduling restrictions.

In some aspects, the first SPS configuration may further indicate a transmission gap between two adjacent semi-static PDSCH occasions in the one or more semi-static PDSCH occasions. For example, referring to FIG. 6, the first SPS configuration may further indicate a transmission gap (e.g., gaps 612, 614, 616) between two adjacent semi-static PDSCH occasions (e.g., between occasions 642 and 644 or between occasions 652 and 654) in the one or more semi-static PDSCH occasions.

In some aspects, the transmission gap may be based on one or more of: the TDRA of the first SPS configuration, or the MCS. For example, referring to FIG. 6, the transmission gap (e.g., gaps 612, 614, 616) may be based on one or more of: the TDRA of the first SPS configuration, or the MCS.

In some aspects, the transmission gap between the two adjacent semi-static PDSCH occasions in the one or more semi-static PDSCH occasions may be greater than or equal to a threshold gap from a first semi-static PDSCH occasion to a second semi-static PDSCH occasion in the one or more semi-static PDSCH occasions. For example, referring to FIG. 8, the transmission gap between the two adjacent semi-static PDSCH occasions in the one or more semi-static PDSCH occasions (e.g., gap 612) may be greater than or equal to a threshold gap, and the threshold gap may be the length of the OFF durations (e.g., at 622) in the duty cycle 620 of the energy efficient scheduling.

In some aspects, the UE may receive a BWP configuration from the network entity. The first SPS configuration may be included in the BWP configuration. For example, referring to FIG. 8, the UE 802 may, at 810, receive a BWP configuration from the network entity (e.g., base station 804). The first SPS configuration may be included in the BWP configuration.

In some aspects, the UE may transmit a first ACK to at least one semi-static PDSCH occasion of the one or more semi-static PDSCH occasions to the network entity. The first time interval between the first ACK and the at least one semi-static PDSCH occasion may be based on the first processing timeline, and the first time interval may be longer than the second time interval between a PDSCH occasion and a second ACK prior to the reception of the indication of the reduced peak throughput mode. For example, referring to FIG. 8, the UE 802 may, at 818, transmit a first ACK to at least one semi-static PDSCH occasion of the one or more semi-static PDSCH occasions to the network entity. The first time interval between the first ACK and the at least one semi-static PDSCH occasion may be based on the first processing timeline, and the first time interval may be longer than the second time interval between a PDSCH occasion and a second ACK prior to the reception of the indication of the reduced peak throughput mode (e.g., at 806).

In some aspects, the UE may receive multiple SPS configurations including the first SPS configuration; and activate the first SPS configuration in response to a periodicity associated with the first SPS configuration being aligned with a duty cycle associated with the scheduling restrictions. For example, referring to FIG. 8, the UE 802 may, at 808 receive multiple SPS configurations including the first SPS configuration; and, at 814, activate the first SPS configuration in response to a periodicity associated with the first SPS configuration being aligned with a duty cycle associated with the scheduling restrictions. Referring to FIG. 6, the multiple SPS configurations may include SPS 1 630, SPS 2 632, SPS 3 634. SPS 1 630 may be activated if its periodicity is aligned with a duty cycle 620 associated with the scheduling restrictions.

In some aspects, the multiple SPS configuration may further include a second SPS configuration for PDSCH occasions, and there is no transmission gap between adjacent PDSCH occasions in the PDSCH occasions associated with the second SPS configuration. For example, referring to FIG. 6, the multiple SPS configuration may further include SPS 3 634, and there is no transmission gap between adjacent PDSCH occasions in the PDSCH occasions associated with SPS 3 634.

In some aspects, to activate the first SPS configuration, the UE may activate the first SPS configuration in response to the reception of the indication of the reduced peak throughput mode. For example, referring to FIG. 8, the UE 802 may, at 814, activate the first SPS configuration in response to the reception of the indication of the reduced peak throughput mode (e.g., at 806).

In some aspects, the UE may receive a set of multiple SPSs, and an extended processing timeline for the last SPS of the set of SPSs may be longer than a common processing timeline for any SPS before the last SPS in the set of SPSs. For example, referring to FIG. 7 and FIG. 8, the UE 802 may, at 816, receive a set of multiple SPSs (e.g., SPS occasions 702, 704, 706, 708), and an extended processing timeline for the last SPS of the set of SPSs may be longer than a common processing timeline for any SPS before the last SPS in the set of SPSs.

In some aspects, a gap duration between adjacent semi-static PDSCH occasions of the one or more semi-static PDSCH occasions may not overlap with a DG PDSCH.

In some aspects, the UE may transmit an uplink transmission using a CG PUSCH occasion to the network entity. The CG PUSCH occasion may overlap with a gap duration between adjacent semi-static PDSCH occasions of the one or more semi-static PDSCH occasions. For example, referring to FIG. 6 and FIG. 8, the UE 802 may, at 820, transmit an uplink transmission using a CG PUSCH occasion (e.g., at 606) to the network entity (e.g., base station 804). The CG PUSCH occasion (e.g., at 606) may overlap with a gap duration (e.g., gap 614) between adjacent semi-static PDSCH occasions of the one or more semi-static PDSCH occasions.

In some aspects, the UE may refrain from transmitting an uplink transmission using a CG PUSCH occasion in response to the CG PUSCH occasion overlapping with a gap duration between adjacent semi-static PDSCH occasions of the one or more semi-static PDSCH occasions. For example, referring to FIG. 8, the UE 802 may, at 822, refrain from transmitting an uplink transmission using a CG PUSCH occasion in response to the CG PUSCH occasion (e.g., at 606) overlapping with a gap duration (e.g., gap 614) between adjacent semi-static PDSCH occasions of the one or more semi-static PDSCH occasions.

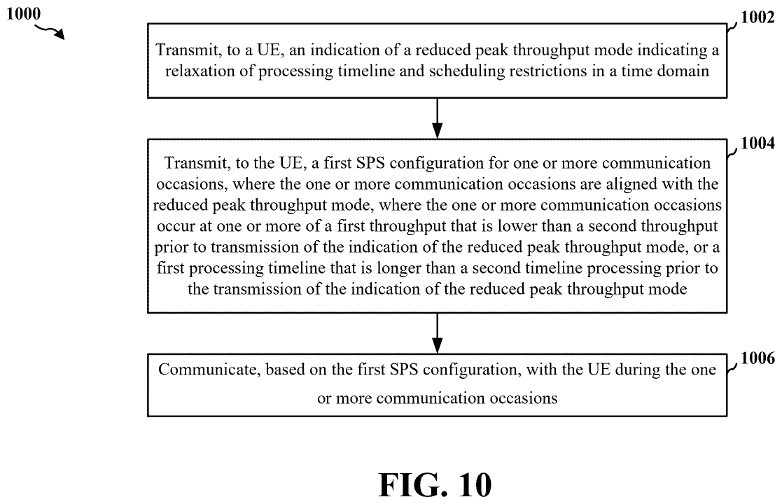

FIG. 10 is a flowchart 1000 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 804; or the network entity 1102 in the hardware implementation of FIG. 11). The UE may be the UE 104, 350, 802, or the apparatus 1104 in the hardware implementation of FIG. 11. By integrating SPS with energy efficient scheduling, the methods reduce the power consumption of UE and improve network resource utilization. Additionally, by allowing UE to select from multiple SPS configurations based on network conditions or UE capability, the methods ensure that resource scheduling can be adapted to varying traffic conditions, such as those from different applications or services, thereby improving the efficiency of wireless communication. In some examples that involve burst traffic, such as XR burst traffic, the methods allow back-to-back PDSCHs when high data rates are needed and provide a relaxed scheduling timeline when lower data rates suffice, thereby improving resource utilization and reducing unnecessary power usage.

As shown in FIG. 10, at 1002, the network entity may transmit an indication of a reduced peak throughput mode to a UE. The indication of the reduced peak throughput mode may indicate a relaxation of the processing timeline and scheduling restrictions in a time domain. FIG. 5, FIG. 6, FIG. 7, and FIG. 8 illustrate various aspects of the steps in connection with flowchart 1000. For example, referring to FIG. 8, the network entity (e.g., base station 804) may, at 806, transmit an indication of a reduced peak throughput mode to a UE 802. The indication of the reduced peak throughput mode may indicate a relaxation of the processing timeline and scheduling restrictions in a time domain. In some aspects, 1002 may be performed by the SPS component 199.

As shown in FIG. 10, at 1004, the network entity may transmit a first SPS configuration for one or more communication occasions to the UE. The one or more communication occasions may be aligned with the reduced peak throughput mode, and the one or more communication occasions may occur at one or more of a first throughput that is lower than a second throughput prior to transmission of the indication of the reduced peak throughput mode, or a first processing timeline that is longer than a second timeline processing prior to the transmission of the indication of the reduced peak throughput mode. For example, referring to FIG. 8, the network entity (e.g., base station 804) may, at 812, transmit a first SPS configuration for one or more communication occasions to the UE 802. Referring to FIG. 6, the one or more communication occasions (e.g., communication occasions 642, 644, 646) may be aligned with the reduced peak throughput mode of the UE (e.g., the duty cycle 620). In some examples, the one or more communication occasions (e.g., communication occasions 642, 644, 646) may occur at a first throughput that is lower than a second throughput prior to reception of the indication of the reduced peak throughput mode (e.g., at 806). In some examples, the one or more communication occasions (e.g., communication occasions 642, 644, 646) may occur at a first processing timeline that is longer than a second timeline processing prior to the reception of the indication of the reduced peak throughput mode (e.g., at 806). In some aspects, 1004 may be performed by the SPS component 199.

As shown in FIG. 10, at 1006, the network entity may communicate with the UE during the one or more communication occasions based on the first SPS configuration. For example, referring to FIG. 8, the network entity (e.g., base station 804) may, at 824, communicate with the UE 802 during the one or more communication occasions (e.g., communication occasions 642, 644, 646) based on the first SPS configuration. In some aspects, 1006 may be performed by the SPS component 199.

In some aspects, the one or more communication occasions may include one or more semi-static PDSCH occasions. For example, referring to FIG. 6 and FIG. 8, the one or more communication occasions (e.g., communication occasions 642, 644, 646) may include one or more semi-static PDSCH occasions 830.

In some aspects, the scheduling restrictions in the time domain may include a first number of guaranteed slots. The UE expects no downlink PDSCH scheduling, PDCCH, CSI-RS, or SSB measurement in the first number of guaranteed slots following a scheduled semi-static PDSCH. For example, referring to FIG. 6, the scheduling restrictions in the time domain may include a first number of guaranteed slots (e.g., the OFF periods of the duty cycle at 622, 624), and the UE expects no downlink PDSCH scheduling, PDCCH, CSI-RS, or SSB measurement in the first number of guaranteed slots (e.g., the OFF periods of the duty cycle at 622, 624) following a scheduled semi-static PDSCH (e.g., PDSCH at 602 or 604).

In some aspects, the number of slots between adjacent semi-static PDSCH occasions of the one or more semi-static PDSCH occasions may be greater than or equal to a gap slot associated with the scheduling restrictions. For example, referring to FIG. 6, the number of slots between adjacent semi-static PDSCH occasions of the one or more semi-static PDSCH occasions (e.g., gaps 612 or 616) may be greater than or equal to the gap slot associated with the scheduling restrictions (e.g., OFF periods of the duty cycle at 622).

In some aspects, the slot offset of the one or more semi-static PDSCH occasions may be aligned with the duty cycle of the UE associated with the scheduling restrictions. For example, referring to FIG. 6, the slot offset of the one or more semi-static PDSCH occasions (e.g., the slot offset at SPS 1 630) may be aligned (or matched) with the duty cycle 620 of the UE associated with the scheduling restrictions.

In some aspects, the one or more semi-static PDSCH occasions may not overlap with one or more OFF periods of the duty cycle of the UE associated with the scheduling restrictions. For example, referring to FIG. 6, the one or more semi-static PDSCH occasions (e.g., occasions 642, 644, 646, 652, 654) may not overlap with one or more OFF periods (e.g., OFF periods at 622, 624) of the duty cycle 620 of the UE associated with the scheduling restrictions.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor (or processing circuitry) 1124 (also referred to as a modem) coupled to one or more transceivers 1122 (e.g., cellular RF transceiver). The cellular baseband processor(s) (or processing circuitry) 1124 may include at least one on-chip memory (or memory circuitry) 1124′. In some aspects, the apparatus 1104 may further include one or more subscriber identity modules (SIM) cards 1120 and at least one application processor (or processing circuitry) 1106 coupled to a secure digital (SD) card 1108 and a screen 1110. The application processor(s) (or processing circuitry) 1106 may include on-chip memory (or memory circuitry) 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) (or processing circuitry) 1124 communicates through the transceiver(s) 1122 via one or more antennas 1180 with the UE 104 and/or with an RU associated with a network entity 1102. The cellular baseband processor(s) (or processing circuitry) 1124 and the application processor(s) (or processing circuitry) 1106 may each include a computer-readable medium/memory (or memory circuitry) 1124′, 1106′, respectively. The additional memory modules 1126 may also be considered a computer-readable medium/memory (or memory circuitry). Each computer-readable medium/memory (or memory circuitry) 1124′, 1106′, 1126 may be non-transitory. The cellular baseband processor(s) (or processing circuitry) 1124 and the application processor(s) (or processing circuitry) 1106 are each responsible for general processing, including the execution of software stored on the computer-readable medium/memory (or memory circuitry). The software, when executed by the cellular baseband processor(s) (or processing circuitry) 1124/application processor(s) (or processing circuitry) 1106, causes the cellular baseband processor(s) (or processing circuitry) 1124/application processor(s) (or processing circuitry) 1106 to perform the various functions described supra. The cellular baseband processor(s) (or processing circuitry) 1124 and the application processor(s) (or processing circuitry) 1106 are configured to perform the various functions described supra based at least in part of the information stored in the memory (or memory circuitry). That is, the cellular baseband processor(s) (or processing circuitry) 1124 and the application processor(s) (or processing circuitry) 1106 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1124/application processor(s) (or processing circuitry) 1106 when executing software. The cellular baseband processor(s) (or processing circuitry) 1124/application processor(s) (or processing circuitry) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) (or processing circuitry) 1124 and/or the application processor(s) (or processing circuitry) 1106, and in another configuration, the apparatus 1104 may be the entire UE (e.g., see UE 350 of FIG. 3) and include the additional modules of the apparatus 1104.

As discussed supra, the component 198 may be configured to receive, from a network entity, an indication of a reduced peak throughput mode indicating a relaxation of the processing timeline and scheduling restrictions in a time domain; receive, from the network entity, a first SPS configuration for one or more communication occasions, where the one or more communication occasions are aligned with the reduced peak throughput mode, where the one or more communication occasions occur at one or more of a first throughput that is lower than a second throughput prior to reception of the indication of the reduced peak throughput mode, or a first processing timeline that is longer than a second timeline processing prior to the reception of the indication of the reduced peak throughput mode; and communicate, based on the first SPS configuration, with the network entity during the one or more communication occasions. The component 198 may be further configured to perform any of the aspects described in connection with the flowchart in FIG. 9, and/or performed by the UE 802 in FIG. 8. The component 198 may be within the cellular baseband processor(s) (or processing circuitry) 1124, the application processor(s) (or processing circuitry) 1106, or both the cellular baseband processor(s) (or processing circuitry) 1124 and the application processor(s) (or processing circuitry) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) (or processing circuitry) 1124 and/or the application processor(s) (or processing circuitry) 1106, includes means for receiving, from a network entity, an indication of a reduced peak throughput mode indicating a relaxation of the processing timeline and scheduling restrictions in a time domain; means for receiving, from the network entity, a first SPS configuration for one or more communication occasions, where the one or more communication occasions are aligned with the reduced peak throughput mode, where the one or more communication occasions occur at one or more of a first throughput that is lower than a second throughput prior to reception of the indication of the reduced peak throughput mode, or a first processing timeline that is longer than a second timeline processing prior to the reception of the indication of the reduced peak throughput mode; and means for communicating, based on the first SPS configuration, with the network entity during the one or more communication occasions. The apparatus 1104 may further include means for performing any of the aspects described in connection with the flowchart in FIG. 9, and/or aspects performed by the UE 802 in FIG. 8. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

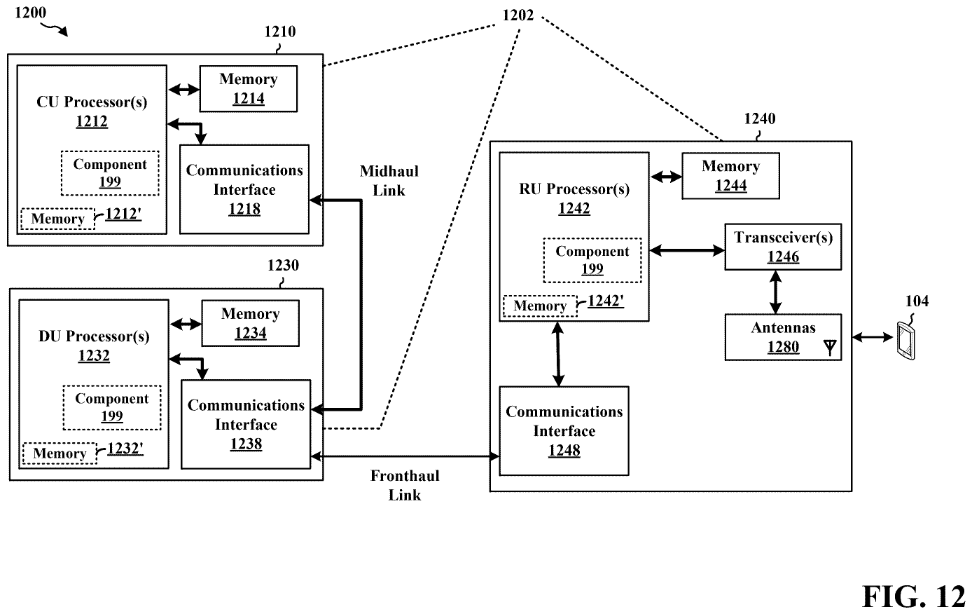

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor (or processing circuitry) 1212. The CU processor(s) (or processing circuitry) 1212 may include on-chip memory (or memory circuitry) 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor (or processing circuitry) 1232. The DU processor(s) (or processing circuitry) 1232 may include on-chip memory (or memory circuitry) 1232′. In some aspects, the DU 1230 may further include additional memory modules 1234 and a communications interface 1238. The DU 1230 communicates with the RU 1240 through a fronthaul link. The RU 1240 may include at least one RU processor (or processing circuitry) 1242. The RU processor(s) (or processing circuitry) 1242 may include on-chip memory (or memory circuitry) 1242′. In some aspects, the RU 1240 may further include additional memory modules 1244, one or more transceivers 1246, antennas 1280, and a communications interface 1248. The RU 1240 communicates with the UE 104. The on-chip memory (or memory circuitry) 1212′, 1232′, 1242′ and the additional memory modules 1214, 1234, 1244 may each be considered a computer-readable medium/memory (or memory circuitry). Each computer-readable medium/memory (or memory circuitry) may be non-transitory. Each of the processors (or processing circuitry) 1212, 1232, 1242 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to transmit, to a UE, an indication of a reduced peak throughput mode indicating a relaxation of the processing timeline and scheduling restrictions in a time domain; transmit, to the UE, a first SPS configuration for one or more communication occasions, where the one or more communication occasions are aligned with the reduced peak throughput mode, where the one or more communication occasions occur at one or more of a first throughput that is lower than a second throughput prior to transmission of the indication of the reduced peak throughput mode, or a first processing timeline that is longer than a second timeline processing prior to the transmission of the indication of the reduced peak throughput mode; and communicate, based on the first SPS configuration, with the UE during the one or more communication occasions. The component 199 may be further configured to perform any of the aspects described in connection with the flowchart in FIG. 10, and/or performed by the base station 804 in FIG. 8. The component 199 may be within one or more processors (or processing circuitry) of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 includes means for transmitting, to a UE, an indication of a reduced peak throughput mode indicating a relaxation of the processing timeline and scheduling restrictions in a time domain; means for transmitting, to the UE, a first SPS configuration for one or more communication occasions, where the one or more communication occasions are aligned with the reduced peak throughput mode, where the one or more communication occasions occur at one or more of a first throughput that is lower than a second throughput prior to transmission of the indication of the reduced peak throughput mode, or a first processing timeline that is longer than a second timeline processing prior to the transmission of the indication of the reduced peak throughput mode; and means for communicating, based on the first SPS configuration, with the UE during the one or more communication occasions. The network entity 1202 may further include means for performing any of the aspects described in connection with the flowchart in FIG. 10, and/or aspects performed by the base station 804 in FIG. 8. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving, from a network entity, an indication of a reduced peak throughput mode indicating a relaxation of the processing timeline and scheduling restrictions in a time domain; receiving, from the network entity, a first SPS configuration for one or more communication occasions, where the one or more communication occasions are aligned with the reduced peak throughput mode, where the one or more communication occasions occur at one or more of a first throughput that is lower than a second throughput prior to reception of the indication of the reduced peak throughput mode, or a first processing timeline that is longer than a second timeline processing prior to the reception of the indication of the reduced peak throughput mode; and communicating, based on the first SPS configuration, with the network entity during the one or more communication occasions. This disclosure proposes different ways of handling SPS when energy efficient scheduling is used. In some examples, a gap follows each PDSCH scheduling in the energy efficient scheduling mode. When the UE is configured with SPSs, an SPS occasion may overlap with the gap. In some examples, for handing DG-PDSCH overlapping the gap, different ways of handling the overlap between SPS and the gap are provided.

For example, the configuration of the SPS periodicity may be restricted to align with the scheduling duty cycle, the SPS occasions overlapping with the gap may be regarded as invalid, or two sets of SPS configurations may be maintained and selected based on the normal mode or energy efficient scheduling mode. By integrating SPS with energy efficient scheduling, the methods reduce the power consumption of UE and improve network resource utilization. Additionally, by allowing UE to select from multiple SPS configurations based on network conditions or UE capability, the methods ensure that resource scheduling can be adapted to varying traffic conditions, such as those from different applications or services, thereby improving the efficiency of wireless communication. In some examples that involve burst traffic, such as XR burst traffic, the methods allow back-to-back PDSCHs when high data rates are needed and provide a relaxed scheduling timeline when lower data rates suffice, thereby improving resource utilization and reducing unnecessary power usage.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method includes receiving, from a network entity, an indication of a reduced peak throughput mode indicating a relaxation of processing timeline and scheduling restrictions in a time domain; receiving, from the network entity, a first semi-persistent scheduling (SPS) configuration for one or more communication occasions, wherein the one or more communication occasions are aligned with the reduced peak throughput mode, wherein the one or more communication occasions occur at one or more of a first throughput that is lower than a second throughput prior to reception of the indication of the reduced peak throughput mode, or a first processing timeline that is longer than a second timeline processing prior to the reception of the indication of the reduced peak throughput mode; and communicating, based on the first SPS configuration, with the network entity during the one or more communication occasions.

Aspect 2 is the method of aspect 1, wherein the one or more communication occasions include one or more semi-static physical downlink shared channel (PDSCH) occasions.

Aspect 3 is the method of any of aspects 1 to 2, wherein the scheduling restrictions in the time domain include a first number of guaranteed slots, wherein the UE expects no downlink (DL) physical downlink shared channel (PDSCH) scheduling, physical downlink control channel (PDCCH), channel state information-reference signal (CSI-RS), or synchronization signal block (SSB) measurement in the first number of guaranteed slots following a scheduled semi-static PDSCH.

Aspect 4 is the method of aspect 3, wherein a number of slots between adjacent semi-static PDSCH occasions of the one or more semi-static PDSCH occasions is greater than or equal to a gap slot associated with the scheduling restrictions.

Aspect 5 is the method of aspect 4, wherein a slot offset of the one or more semi-static PDSCH occasions is aligned with a duty cycle of the UE associated with the scheduling restrictions.

Aspect 6 is the method of aspect 3, wherein the one or more semi-static PDSCH occasions do not overlap with one or more OFF periods of a duty cycle of the UE associated with the scheduling restrictions.

Aspect 7 is the method of aspect 2, wherein the first SPS configuration further indicates a transmission gap between two adjacent semi-static PDSCH occasions in the one or more semi-static PDSCH occasions.

Aspect 8 is the method of aspect 7, wherein the transmission gap is based on one or more of: a time-domain resource allocation (TDRA) of the first SPS configuration, or a modulation and coding scheme (MCS).

Aspect 9 is the method of aspect 7, wherein the transmission gap between the two adjacent semi-static PDSCH occasions in the one or more semi-static PDSCH occasions is greater than or equal to a threshold gap from a first semi-static PDSCH occasion to a second semi-static PDSCH occasion in the one or more semi-static PDSCH occasions.

Aspect 10 is the method of any of aspects 1 to 2, where the method further includes receiving, from the network entity, a bandwidth part (BWP) configuration, wherein the first SPS configuration is included in the BWP configuration.

Aspect 11 is the method of aspect 2, where the method further includes transmitting, to the network entity, a first acknowledgement (ACK) to at least one semi-static PDSCH occasion of the one or more semi-static PDSCH occasions, wherein a first time interval between the first ACK and the at least one semi-static PDSCH occasion is based on the first processing timeline, and wherein the first time interval is longer than a second time interval between a PDSCH occasion and a second ACK prior to the reception of the indication of the reduced peak throughput mode.

Aspect 12 is the method of any of aspects 1 to 2, where the method further includes receiving multiple SPS configurations including the first SPS configuration; and activating the first SPS configuration in response to a periodicity associated with the first SPS configuration being aligned with a duty cycle associated with the scheduling restrictions.

Aspect 13 is the method of aspect 12, wherein the multiple SPS configuration further includes a second SPS configuration for PDSCH occasions, wherein there is no transmission gap between adjacent PDSCH occasions in the PDSCH occasions associated with the second SPS configuration.

Aspect 14 is the method of aspect 12, wherein activating the first SPS configuration includes activating the first SPS configuration in response to the reception of the indication of the reduced peak throughput mode.

Aspect 15 is the method of any of aspects 1 to 2, where the method further includes receiving a set of multiple SPSs, wherein an extended processing timeline for a last SPS of the set of SPSs is longer than a common processing timeline for any SPS before the last SPS in the set of SPSs.

Aspect 16 is the method of aspect 2, wherein a gap duration between adjacent semi-static PDSCH occasions of the one or more semi-static PDSCH occasions does not overlap with a dynamically scheduled (DG) PDSCH.

Aspect 17 is the method of aspect 2, where the method further includes transmitting, to the network entity, an uplink transmission using a configured grant (CG) physical uplink shared channel (PUSCH) occasion, wherein the CG PUSCH occasion overlaps with a gap duration between adjacent semi-static PDSCH occasions of the one or more semi-static PDSCH occasions.

Aspect 18 is the method of aspect 2, where the method further includes refraining from transmitting an uplink transmission suing a configured grant (CG) physical uplink shared channel (PUSCH) occasion in response to the CG PUSCH occasion overlapping with a gap duration between adjacent semi-static PDSCH occasions of the one or more semi-static PDSCH occasions.

Aspect 19 is an apparatus for wireless communication at a UE, comprising: a processing system that includes processor circuitry and memory circuitry that stores code and is coupled with the processor circuitry, the processing system configured to cause the UE to perform the method of one or more of aspects 1-18.

Aspect 20 is an apparatus for wireless communication at a UE, comprising: at least one memory; and at least one processor coupled to the at least one memory and, where the at least one processor is configured to perform the method of any of aspects 1-18.

Aspect 21 is the apparatus for wireless communication at a UE, comprising means for performing each step in the method of any of aspects 1-18.

Aspect 22 is an apparatus of any of aspects 19-21, further comprising a transceiver configured to receive or to transmit in association with the method of any of aspects 1-18.

Aspect 23 is a computer-readable medium (e.g., a non-transitory computer-readable medium) storing computer executable code at a UE, the code when executed by at least one processor causes the at least one processor to perform the method of any of aspects 1-18.

Aspect 24 is a method of wireless communication at a network entity. The method includes transmitting, to a user equipment (UE), an indication of a reduced peak throughput mode indicating a relaxation of processing timeline and scheduling restrictions in a time domain; transmitting, to the UE, a first semi-persistent scheduling (SPS) configuration for one or more communication occasions, wherein the one or more communication occasions are aligned with the reduced peak throughput mode, wherein the one or more communication occasions occur at one or more of a first throughput that is lower than a second throughput prior to transmission of the indication of the reduced peak throughput mode, or a first processing timeline that is longer than a second timeline processing prior to the transmission of the indication of the reduced peak throughput mode; and communicating, based on the first SPS configuration, with the UE during the one or more communication occasions.

Aspect 25 is the method of aspect 24, wherein the one or more communication occasions include one or more semi-static physical downlink shared channel (PDSCH) occasions.

Aspect 26 is the method of any of aspects 24 to 25, wherein the scheduling restrictions in the time domain include a first number of guaranteed slots, wherein the UE expects no downlink (DL) physical downlink shared channel (PDSCH) scheduling, physical downlink control channel (PDCCH), channel state information-reference signal (CSI-RS), or synchronization signal block (SSB) measurement in the first number of guaranteed slots following a scheduled semi-static PDSCH.

Aspect 27 is the method of aspect 26, wherein a number of slots between adjacent semi-static PDSCH occasions of the one or more semi-static PDSCH occasions is greater than or equal to a gap slot associated with the scheduling restrictions.

Aspect 28 is the method of aspect 27, wherein a slot offset of the one or more semi-static PDSCH occasions is aligned with a duty cycle of the UE associated with the scheduling restrictions.

Aspect 29 is the method of aspect 26, wherein the one or more semi-static PDSCH occasions do not overlap with one or more OFF periods of a duty cycle of the UE associated with the scheduling restrictions.

Aspect 30 is an apparatus for wireless communication at a network entity, comprising: a processing system that includes processor circuitry and memory circuitry that stores code and is coupled with the processor circuitry, the processing system configured to cause the network entity to perform the method of one or more of aspects 24-29.

Aspect 31 is an apparatus for wireless communication at a network entity, comprising: at least one memory; and at least one processor coupled to the at least one memory and, where the at least one processor is configured to perform the method of any of aspects 24-29.

Aspect 32 is the apparatus for wireless communication at a network entity, comprising means for performing each step in the method of any of aspects 24-29.

Aspect 33 is an apparatus of any of aspects 30-32, further comprising a transceiver configured to receive or to transmit in association with the method of any of aspects 24-29.

Aspect 34 is a computer-readable medium (e.g., a non-transitory computer-readable medium) storing computer executable code at a network entity, the code when executed by at least one processor causes the at least one processor to perform the method of any of aspects 24-29.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive, from a network entity, an indication of a reduced peak throughput mode indicating a relaxation of processing timeline and scheduling restrictions in a time domain;
receive, from the network entity, a first semi-persistent scheduling (SPS) configuration for one or more communication occasions, wherein the one or more communication occasions are aligned with the reduced peak throughput mode, wherein the one or more communication occasions occur at one or more of a first throughput that is lower than a second throughput prior to reception of the indication of the reduced peak throughput mode, or a first processing timeline that is longer than a second timeline processing prior to the reception of the indication of the reduced peak throughput mode; and
communicate, based on the first SPS configuration, with the network entity during the one or more communication occasions.

2. The apparatus of claim 1, further comprising a transceiver coupled to the at least one processor, wherein to receive the indication of the reduced peak throughput mode, the at least one processor is configured to receive the indication of the reduced peak throughput mode via the transceiver, wherein the one or more communication occasions include one or more semi-static physical downlink shared channel (PDSCH) occasions.

3. The apparatus of claim 2, wherein the scheduling restrictions in the time domain include a first number of guaranteed slots, wherein the UE expects no downlink (DL) physical downlink shared channel (PDSCH) scheduling, physical downlink control channel (PDCCH), channel state information-reference signal (CSI-RS), or synchronization signal block (SSB) measurement in the first number of guaranteed slots following a scheduled semi-static PDSCH.

4. The apparatus of claim 3, wherein a number of slots between adjacent semi-static PDSCH occasions of the one or more semi-static PDSCH occasions is greater than or equal to a gap slot associated with the scheduling restrictions.

5. The apparatus of claim 4, wherein a slot offset of the one or more semi-static PDSCH occasions is aligned with a duty cycle of the UE associated with the scheduling restrictions.

6. The apparatus of claim 3, wherein the one or more semi-static PDSCH occasions do not overlap with one or more OFF periods of a duty cycle of the UE associated with the scheduling restrictions.

7. The apparatus of claim 2, wherein the first SPS configuration further indicates a transmission gap between two adjacent semi-static PDSCH occasions in the one or more semi-static PDSCH occasions.

8. The apparatus of claim 7, wherein the transmission gap is based on one or more of:
a time-domain resource allocation (TDRA) of the first SPS configuration, or
a modulation and coding scheme (MCS).

9. The apparatus of claim 7, wherein the transmission gap between the two adjacent semi-static PDSCH occasions in the one or more semi-static PDSCH occasions is greater than or equal to a threshold gap from a first semi-static PDSCH occasion to a second semi-static PDSCH occasion in the one or more semi-static PDSCH occasions.

10. The apparatus of claim 2, wherein the at least one processor is further configured to:
receive, from the network entity, a bandwidth part (BWP) configuration, wherein the first SPS configuration is included in the BWP configuration.

11. The apparatus of claim 2, wherein the at least one processor is further configured to:
transmit, to the network entity, a first acknowledgement (ACK) to at least one semi-static PDSCH occasion of the one or more semi-static PDSCH occasions, wherein a first time interval between the first ACK and the at least one semi-static PDSCH occasion is based on the first processing timeline, and wherein the first time interval is longer than a second time interval between a PDSCH occasion and a second ACK prior to the reception of the indication of the reduced peak throughput mode.

12. The apparatus of claim 2, wherein the at least one processor is further configured to:
receive multiple SPS configurations including the first SPS configuration; and
activate the first SPS configuration in response to a periodicity associated with the first SPS configuration being aligned with a duty cycle associated with the scheduling restrictions.

13. The apparatus of claim 12, wherein the multiple SPS configuration further includes a second SPS configuration for PDSCH occasions, wherein there is no transmission gap between adjacent PDSCH occasions in the PDSCH occasions associated with the second SPS configuration.

14. The apparatus of claim 12, wherein to activate the first SPS configuration, the at least one processor is configured to:
activate the first SPS configuration in response to the reception of the indication of the reduced peak throughput mode.

15. The apparatus of claim 2, wherein the at least one processor is further configured to:
receive a set of multiple SPSs, wherein an extended processing timeline for a last SPS of the set of SPSs is longer than a common processing timeline for any SPS before the last SPS in the set of SPSs.

16. The apparatus of claim 2, wherein a gap duration between adjacent semi-static PDSCH occasions of the one or more semi-static PDSCH occasions does not overlap with a dynamically scheduled (DG) PDSCH.

17. The apparatus of claim 2, wherein the at least one processor is further configured to:
transmit, to the network entity, an uplink transmission using a configured grant (CG) physical uplink shared channel (PUSCH) occasion, wherein the CG PUSCH occasion overlaps with a gap duration between adjacent semi-static PDSCH occasions of the one or more semi-static PDSCH occasions.

18. The apparatus of claim 2, wherein the at least one processor is further configured to:
refrain from transmitting an uplink transmission using a configured grant (CG) physical uplink shared channel (PUSCH) occasion in response to the CG PUSCH occasion overlapping with a gap duration between adjacent semi-static PDSCH occasions of the one or more semi-static PDSCH occasions.

19. An apparatus for wireless communication at a network entity, comprising:
at least one memory; and
at least one processor coupled to the at least one memory and, based at least in part on information stored in the at least one memory, the at least one processor is configured to:
transmit, to a user equipment (UE), an indication of a reduced peak throughput mode indicating a relaxation of processing timeline and scheduling restrictions in a time domain;
transmit, to the UE, a first semi-persistent scheduling (SPS) configuration for one or more communication occasions, wherein the one or more communication occasions are aligned with the reduced peak throughput mode, wherein the one or more communication occasions occur at one or more of a first throughput that is lower than a second throughput prior to transmission of the indication of the reduced peak throughput mode, or a first processing timeline that is longer than a second timeline processing prior to the transmission of the indication of the reduced peak throughput mode; and
communicate, based on the first SPS configuration, with the UE during the one or more communication occasions.

20. A method of wireless communication at a user equipment (UE), comprising:
receiving, from a network entity, an indication of a reduced peak throughput mode indicating a relaxation of processing timeline and scheduling restrictions in a time domain;
receiving, from the network entity, a first semi-persistent scheduling (SPS) configuration for one or more communication occasions, wherein the one or more communication occasions are aligned with the reduced peak throughput mode, wherein the one or more communication occasions occur at one or more of a first throughput that is lower than a second throughput prior to reception of the indication of the reduced peak throughput mode, or a first processing timeline that is longer than a second timeline processing prior to the reception of the indication of the reduced peak throughput mode; and
communicating, based on the first SPS configuration, with the network entity during the one or more communication occasions.
